(19) United States
(12) Patent Application Publication
(10) Pub. No.: US 2019/0178027 A1
(43) Pub. Date: Jun. 13, 2019

(54) Adjustable Flood Barrier Assembly

(71) Applicant: Chandra Sekharam Tangudu, Katy, TX (US)

(72) Inventor: Chandra S. Tangudu, Katy, TX (US)

(21) Appl. No.: 15/836,852

(22) Filed: Dec. 9, 2017

(51) Int. Cl. E06B 9/02

(52) U.S. Cl. CPC E06B 9/02; E06B 2009/007

(57) ABSTRACT

An adjustable flood barrier assembly is removable, temporary and D.I.Y. (Do It Yourself) flood barrier. It consists of panels, and structural framing members, that can be customized for varying sizes of doorway openings, which will cover most residential doors. Once installed at doorway openings, it will prevent flood damage to buildings due to water ingress through door openings during storms or floods. The proposed barrier can resist water pressure and prevent water ingress into buildings up to a few feet of water. The assembly is narrow enough to fit within the gap between outer face of door and outer edge of jamb of usual doors in buildings, and can be installed just outside the door so that door can be closed or opened as desired. It consists of impervious panels, and sliding type so that they can be adjusted to suite to various widths. These panels will connect to horizontal members which bear on jambs. A flexible rubber seal with hydrophilic layer is provided between jambs and sill, and the panel edge returns. The rubber seal is pressed hard against sill and jambs by advancing screws. The screws are supported by legs attached to horizontal members mentioned above, and to vertical members. A vertical member is provided between head of door frame and sill. Panels in flood barrier can be further described as lower panels and upper panels. The height of lower panel is designed such that the occupants can easily walk over the panels for low height of flood waters. In the event that high flood is expected, an extra extendable facility is included. An additional panel and an extendable flexible water proof cloth is included in the system so that one can easily extend the extra height requirement if water height is going to exceed the height of lower panels. Once the flood threat is over, the assembly can be disassembled and stowed. It is an easily assembled system needs no drilling to door frame, or to the floor, instead it takes advantage of bearing strength of door frame to gain stability.

### REFERENCES CITED

U.S. Pat. No. 9,702,182 B July 2017 Wexler

U.S. Pat. No. 9,453,316 B September 2016 Cadogan et al. FIELD OF INVENTION

A temporary removable flood barrier assembly is to protect buildings from ingress of flood water from storms, or unexpected flood threats. The barrier blocks water entry and seals water leakage into building at doorway openings. A flood barrier assembly can be easily deployed when required and stowed after the flood threat is over, it is an ‘Do It Yourself’ flood barrier. When deployed, it does not block the door operation. Occupants can walk over for the barrier when only lower part of barrier is installed.

### BACKGROUND OF THE INVENTION

Due to heavy storm water, especially in low lying areas where drainage was not adequately designed, or due to release of water from dams, if water level increases at exterior door sill level (or, sometimes interior door), water will enter inside the buildings because usual doors are not designed to prevent water entry. Based on duration of water in the buildings, water damage to property will vary. The proposed barrier assembly is to avoid water ingress into building so property inside can be protected.

There have been several techniques to prevent inundation of flood water. Few techniques are blocking storm water around buildings like sand bags, and some other techniques are blocking water flow at entrance or doorway openings by providing barrier by making few modifications to existing structures.

The present invention is related to easily assembled or removable flood barrier in buildings at door openings to avoid damage to buildings due to ingress of water. The proposed invention does not involve drilling any bolts to existing door frame or structure.

U.S. Pat. No 9,453,316 shows an extendible flexible flood barrier, and U.S. Pat. No 9,702,182, flood barrier shield system, both involve drilling to existing members of the buildings. The proposed invention does not involve drilling to existing members of the building, but takes advantage of bearing strength of door frame. The proposed pre-molded or pre-prepared ‘L’ shaped seal at corners will make the water entry tight at corners.

Occupants can assemble in two stages, few parts can be assembled well before flood threat to suite to width of door and jambs, and few more adjustments and assembling right before threat.

### SUMMARY OF THE INVENTION

The present invention consists of three parts, one part consists of panels, other part consists of stabilizing structural members; and another part consists of structural frame to close the gap between the panels and door frame water tight. There are four panels, two panels are below and two panels are above. Both pairs of lower and upper panels are designed to slide on one on the other. The upper panels are provided with flexible waterproof cloth in case of extended height of barrier is required. A system of horizontal and vertical members is provided in order to stabilize panels, and these members are also attached with screw legs. Horizontal members and vertical members will support screw legs which will support screws. When screw is turned by a L-Key, screw will advance and press rigid plate so that panel's edges which are slightly flexible will press flexible seal against jambs and sill. The gap between jambs and sill and panels edges, if any, will get closed, and make the gap water tight. All the structural assembly gets stability without drilling holes in the existing building's door frame, instead the assembly gets stability by bearing strength of jambs, sill and head.

Panels facing water side resist water pressure by holding on to horizontal members which in turn bears on jambs. Structural frame supports the screw legs, which will keep pressure on the panels' edges to prevent water leak through gaps where seal is provided.

The lower panels are designed to a height where occupants can walk over easily. The upper panels are designed in such a way that occupants can easily extend the flexible cloth if water level exceed the lower panel.

The barrier is light weight, occupies less space, and can be easily assembled, it's D.I.Y. (Do It Yourself) flood barrier.

### DESCRIPTION OF DRAWINGS

FIG. 1 shows elevation of flood barrier system from inside the building. This shows panels, horizontal members, upper panels with cloth to extend the barrier, screw legs and vertical members.

FIG. 2 shows elevation of flood barrier system from outside the building. This shows panels, horizontal members, cloth to extend the barrier, and vertical members.

FIG. 3 shows elevation of panels from inside the building without the vertical frame assembly. The panels are joined with a tape to make the joint water tight. Panel return with seal at bottom, flat plate to press and screw leg also can be seen. This is to show system of screw legs and panel edges.

FIG. 4 shows structural frame without panels, the frame shown supports screw legs, and keeps the pressure on the water seal.

FIG. 5 shows system of horizontal and vertical members which will support loads from panels and, will transfer to jambs through side brackets

FIG. 6 shows section 1-1, flood barrier assembly sideways at panels. This depicts top panels, bottom panels, flexible cloth, horizontal members, screw leg, water seal on sill, panel bottom return, flat plate and string.

FIG. 7 shows detail-1, seal at corner with plates, screw to tighten the plate and cross bar. The seal at corner is pre-molded or pre-prepared ‘L’ shaped and it shall be wrapped with tape to a straight seal.

FIG. 8 shows plate arrangement to suite to different widths of door.

FIG. 9 shows Detail-3, connection of tab of panel and horizontal members

FIG. 10 shows Detail-4, bottom panel supporting top panel, and joint of bottom panel to flexible cloth with water proof tape.

FIG. 11 shows more enlarged details of screw leg, screw, plate, panel and seal.

FIG. 12 shows adjustable connection of horizontal member to both sides of jamb.

FIG. 13 shows assembly of horizontal member, screw leg, vertical plate, seal and panel return and jamb.

FIG. 14 shows adjustable connection of horizontal member to outside face of jambs.

FIG. 15 shows lower left panel from inside the building, this shows guides on panel to accommodate flat plates, water seal and elastic rubber sheet.

FIG. 16 shows gaps within the frame (between jambs and sill) which can be filled with grout or hydrophilic material.

### DETAILED DESCRIPTION OF ADJUSTABLE FLOOD BARRIER ASSEMBLY

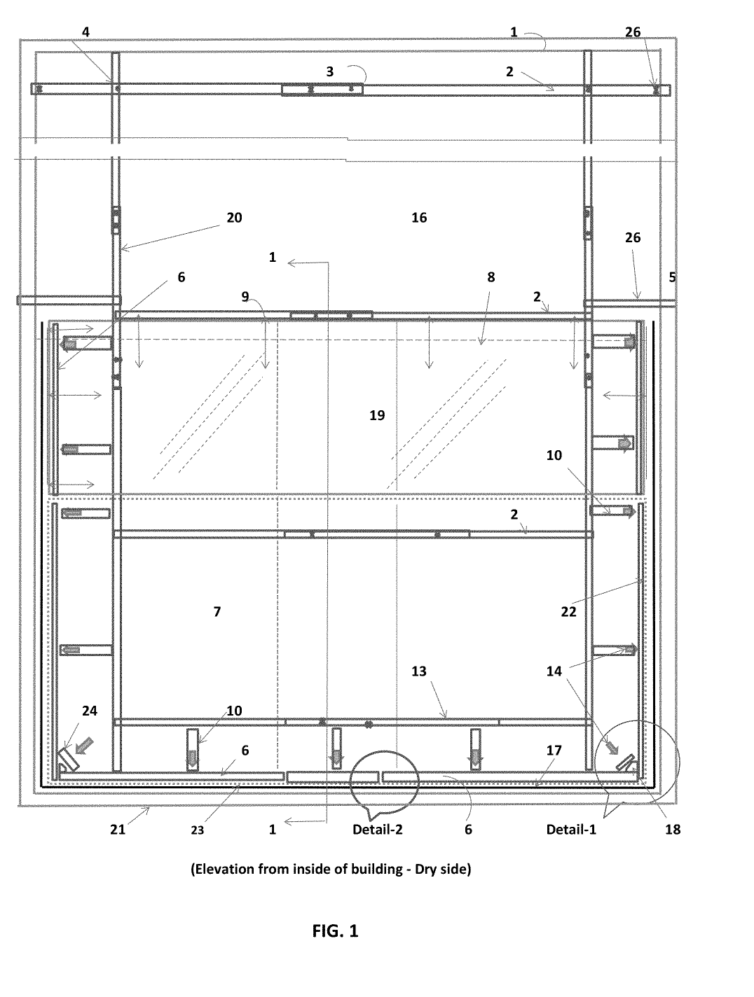

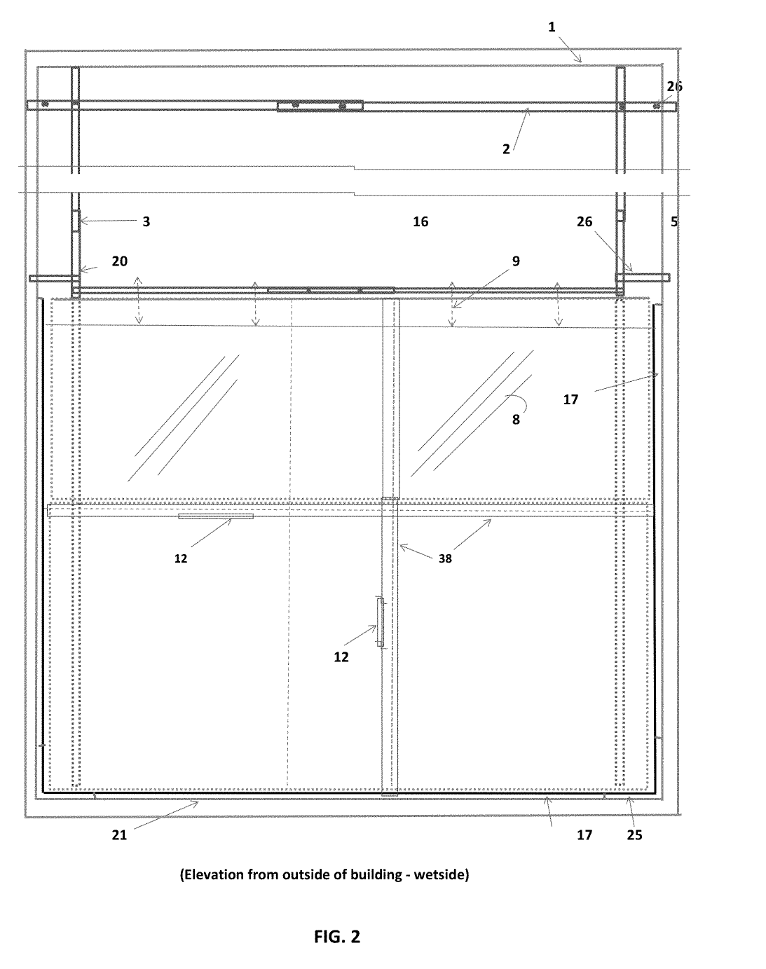

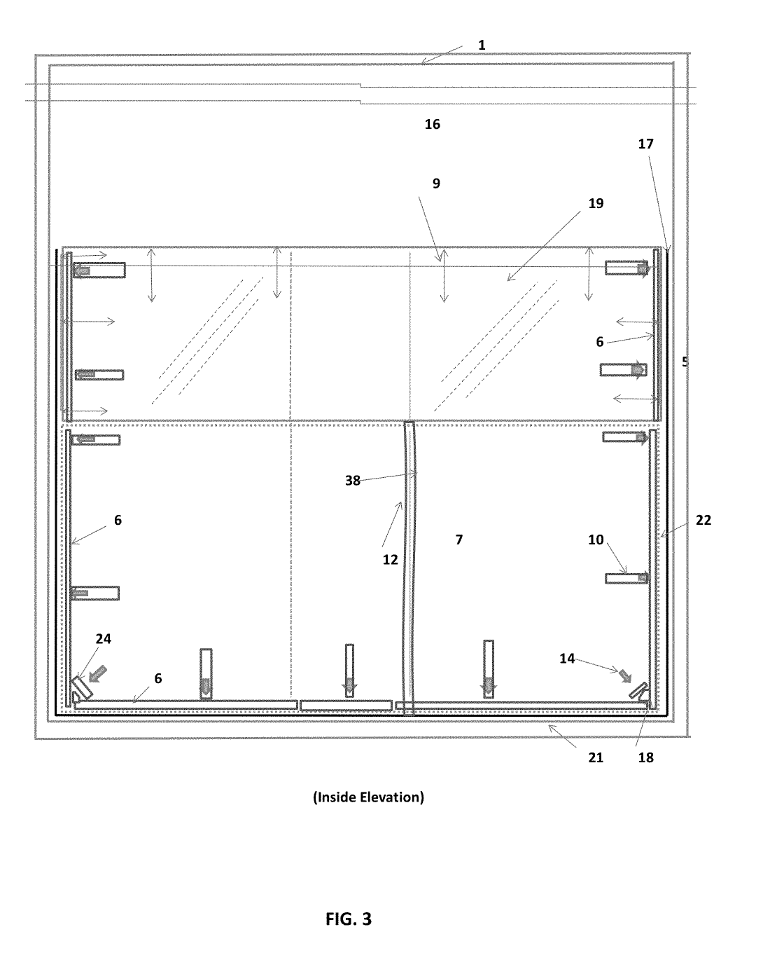

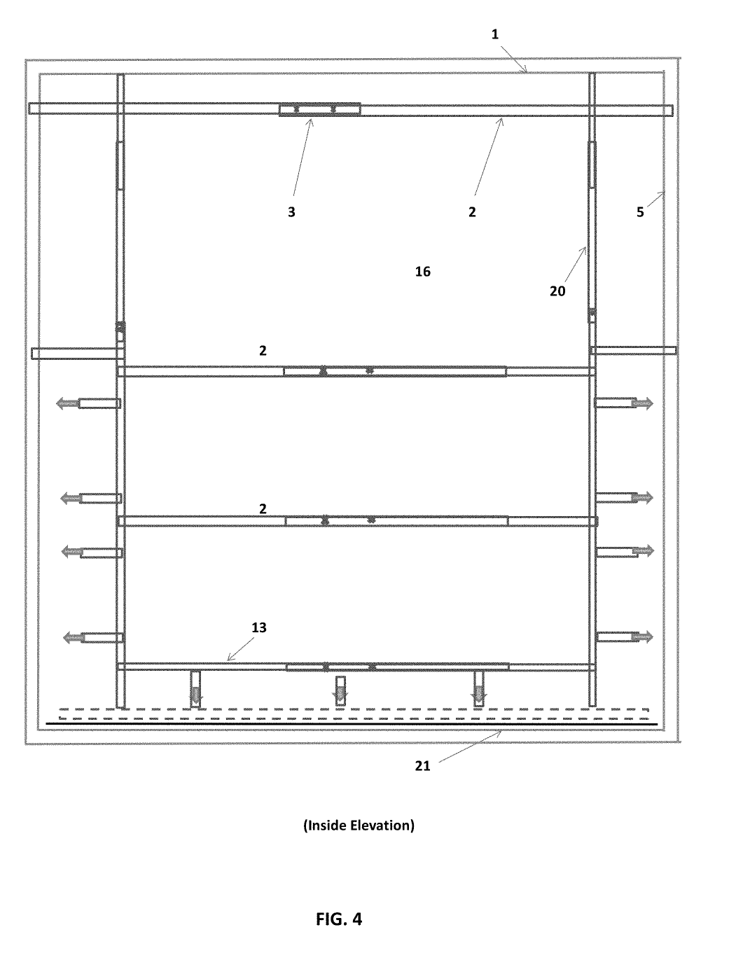

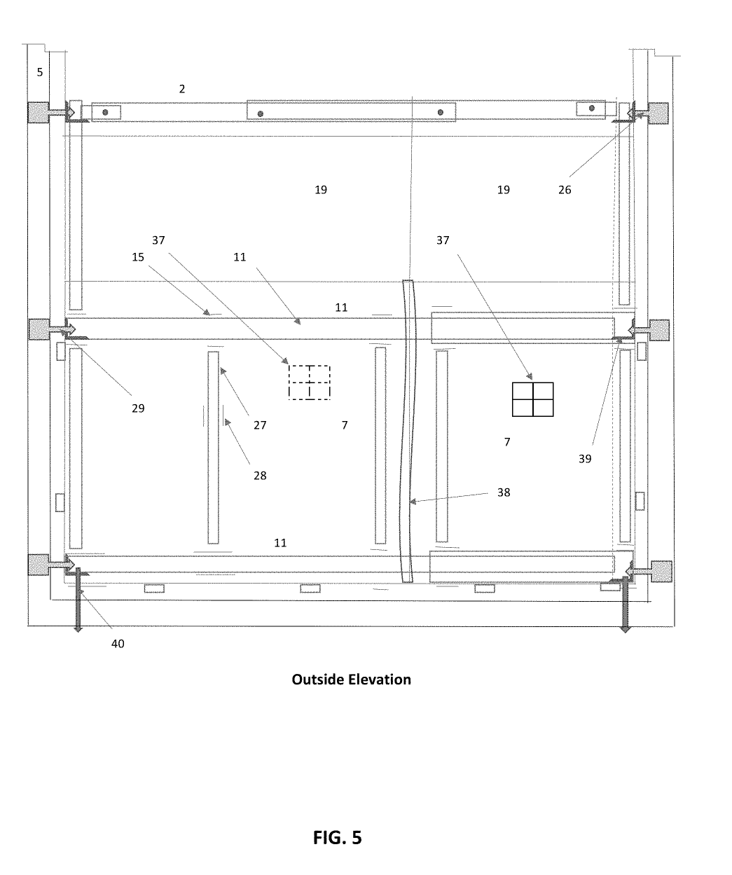

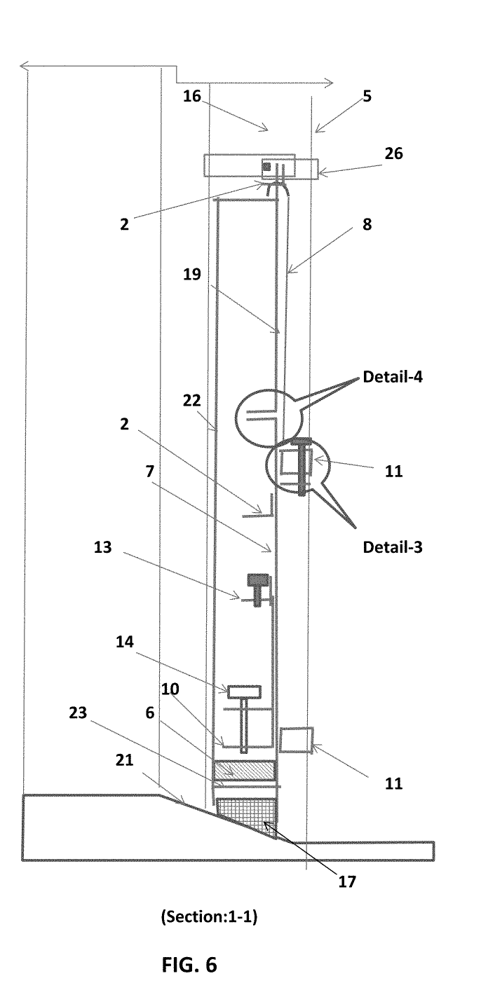

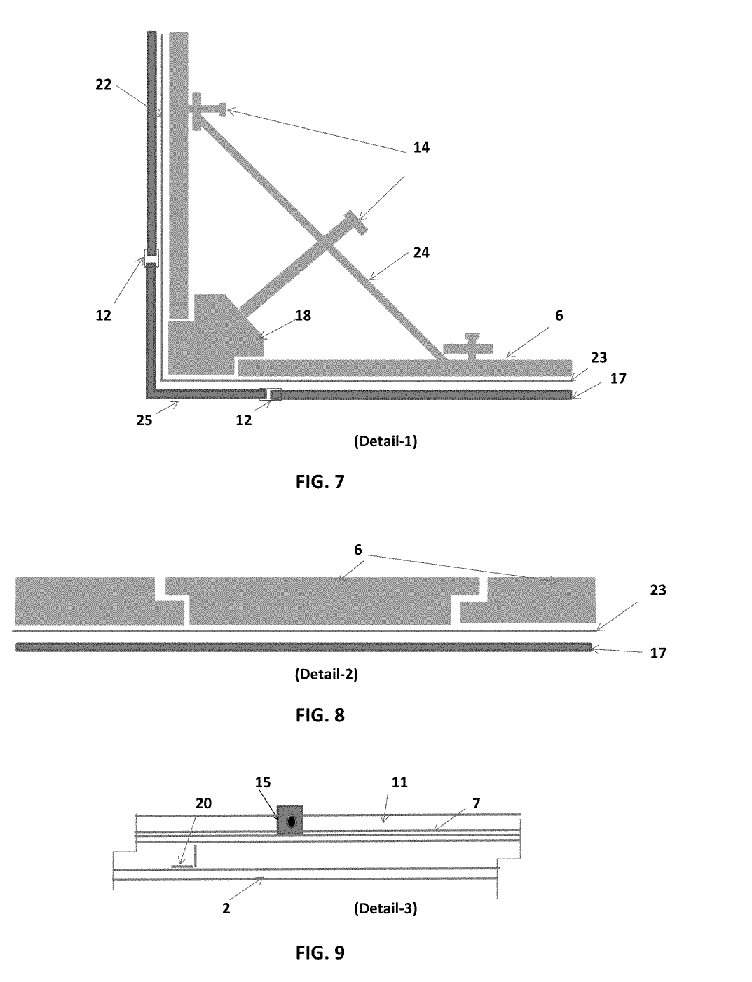

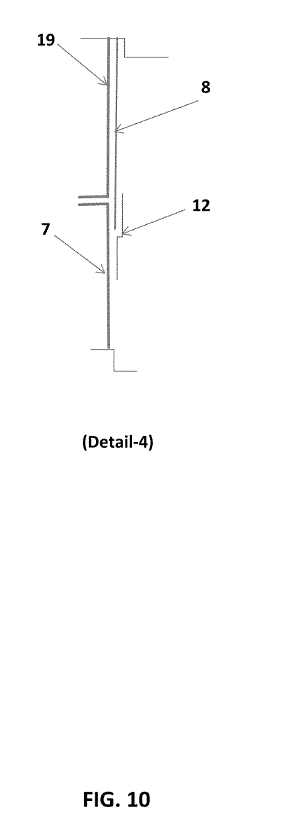

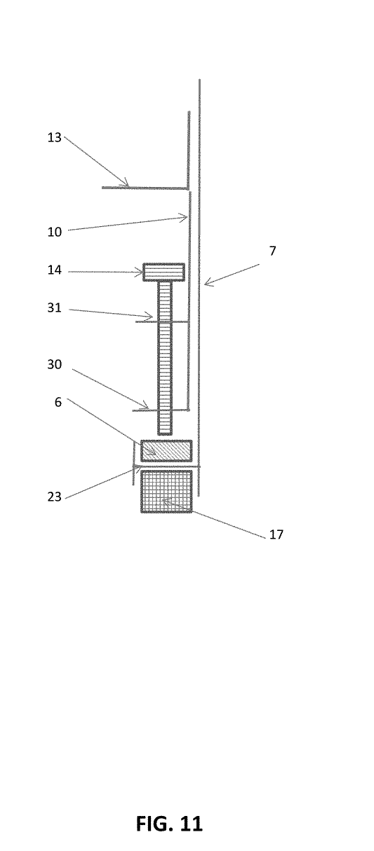

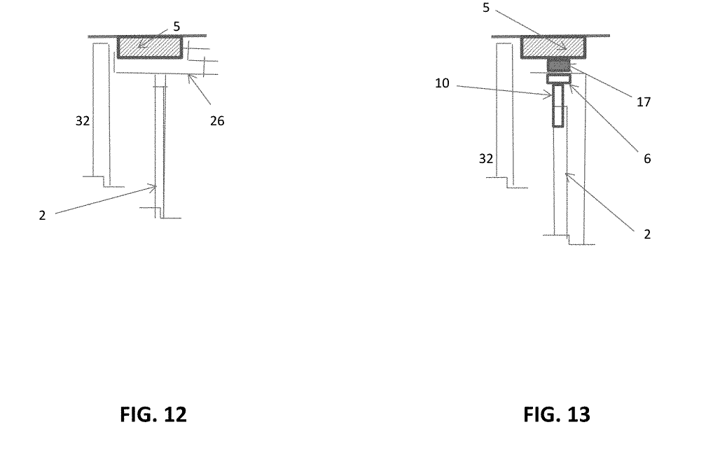

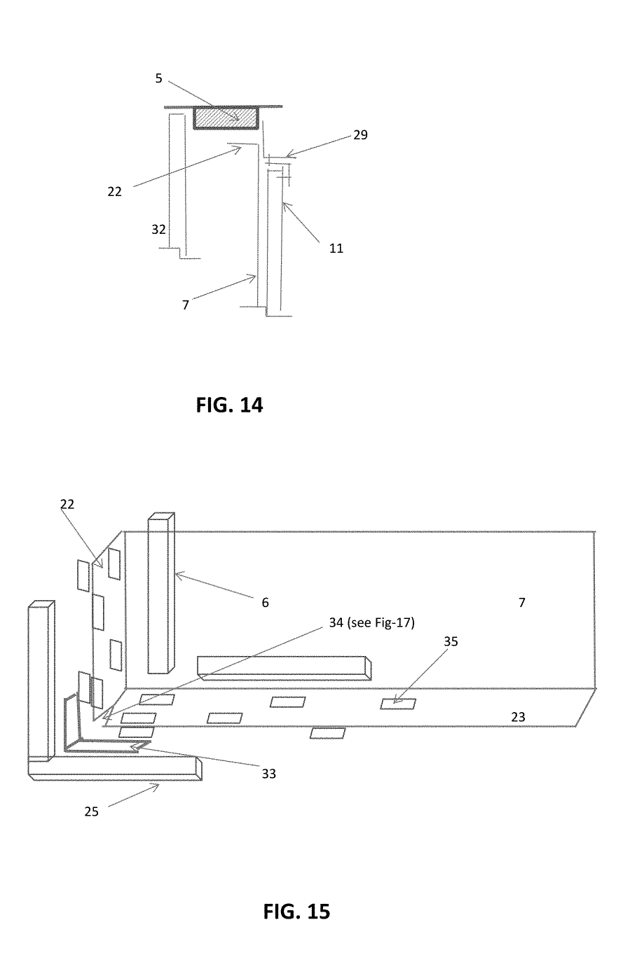

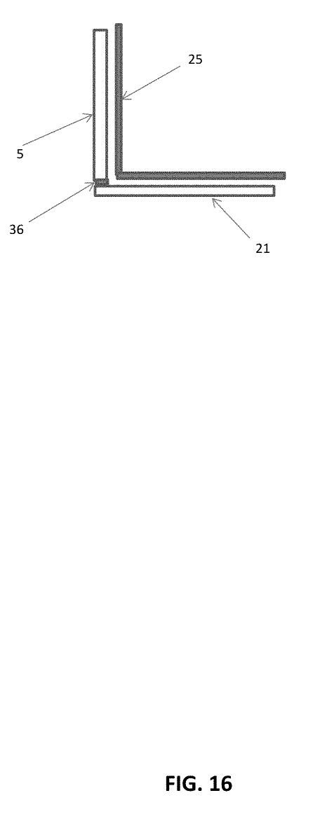

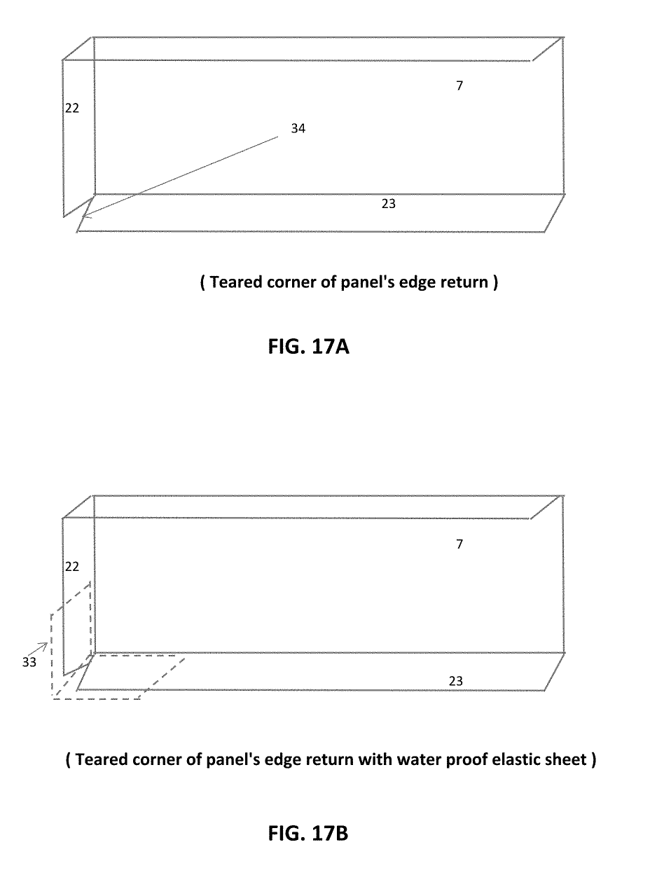

The following description has reference to the FIGS. 1 though FIG. 16 as shown on previous pages.

The flood barrier system is a quick and easily assembled and deployable system at doorway opening 16. The flood barrier is thin and narrow in order to accommodate within the space between the outer edge of jamb and outer face of door 32. The water proof panels 7 & 19 each come in pair, one can slide on the other so that the barrier system can suite to door opening 16 with widths in a usual range. The panels can be sealed with water proof tape 12 over folded water proof rubber sheet 38, which is placed on both sides of the panels, and can be stowed well before actual requirement of flood water threat. Panels come with 90 degrees edge returns 22 and 23, the panel edge returns come with guide tabs 35 to accommodate water seal with hydrophilic layer 17 and flat plates 6. The edge returns are teared 34 at the corner and taped with elastic rubber sheet 33 to allow movement of edges and accommodate uneven surface of sill. The edges come with guides 35 where flat plates 6 on one side and flexible water seal with hydrophilic layer 17 on the otherside can be placed and pressed against jambs 5 and sill 21. Vertical 20 members are formed with splice 3 so that height of members can be adjusted to suite to varying height of door openings, and also it's easy to store. Vertical members bear against head 1 at top so that pressure can be applied on the seal at sill. Horizontal members 2 and 13 are connected to panel tabs 15 and 28 to resist and transfer lateral load from water to jambs. Horizontal members 2 & 13 are connected to vertical members 4 in order to stabilize vertical members in both directions. Panel horizontal members are designed to bear against jambs with adjustable brackets 26 and 29. Screw legs 10 are attached to horizontal members 2 and vertical members 20. Screws 14 advance through the screw leg which has internal threads 30 and oversized hole at top 31, using L-key screws can be turned to advance and apply force on flat plates 6 which are secured by tab guides 35 on the edges. Panels come with returns 22 and 13 where they meat jambs and sill. The tab at the returns will house flat plates on onside and secure seal on the other side. Seal touching jambs and sill will be one side of the panel returns and flat plates will be on the other side of the panel returns. The screw when turned through the leg will apply pressure on the flat plate, the plates push the panel and seal to achieve water tight joint. At the corners, a specially shaped corner block 18 is used with a cross bar 24. The cross bars come with slotted holes and will be loosely fastened to flat plates 6 so that it leaves flexibility of movement of flat plates. The cross bar also comes with threaded hole so that a screw can be advanced and applied force on the corner block to make the seal water tight. The seal at corner is either pre-molded 25 or properly taped prior to placing in the panels edges to make a L shape. The flat plates 6 also shaped such that they can apply uniform pressure on the seal. The top panel is used when water is expected to exceed the height of lower panel. The water proof flexible cloth 8 is taped to lower panel and let hang lose when water threat is not critical, and raised to and tied with a string 9 when required.

When occupants decide to raise height of barrier, the upper panels shall be placed in position on top of lower panels, the cloth shall be wrapped at the edges with a flat plate and which can be placed inside the panel returns. After raising the cloth and tying the strings, screws shall be turned to push the flat plate and to press the seal against the jambs. The gaps within the frame (between jambs and sill) can be filled with grout or hydrophilic material 36. The panels are provided with stiffeners 37 in both directions to stiffen the panel so that panels can be light weight and strong enough to take water pressure. A horizontal leg 39 is attached to exterior horizontal beam, and vertical bolt 40 to adjust the height from floor.

The proposed invention will work well based on accuracy of fabrication and instalment, minor modifications may be required during testing, and may not have been shown and explained above.

1-14. (canceled)

15. An adjustable flood barrier assembly comprising: (a) a frame comprising vertical members, horizontal members and adjustable connection brackets; (b) a plurality of panels comprising panel edge returns, screw legs, flat plate, and tabs; and (c) a water seal.
wherein said adjustable connection brackets of said frame supports said panels.

16. The adjustable flood barrier of claim 15, wherein said panels further comprise guide tabs and are arranged to accommodate said flat plate and water seal.

17. The adjustable flood barrier of claim 15, wherein said screw legs comprise a plurality of screws for communication with said flat plate to apply pressure onto said water seal.

18. The adjustable flood barrier of claim 17, wherein said screw legs further comprise a plate with internally threaded hole to hold said screw in position wherein said screw is in communication with said flat plate when advanced and tightened to apply pressure onto said water seal.

19. The adjustable flood barrier of claim 15, wherein said pluralities of panels comprise adjustable lower panels and adjustable upper panels to allow adjustments in the panel dimensions.

20. The adjustable flood barrier of claim 19, wherein the width of the panel is adjusted by a pair of lower panels that are arranged to horizontally slide onto each other.

21. The adjustable flood barrier of claim 19, wherein width of the panel is adjusted by a pair of upper panels that are arranged to horizontally slide onto each other.

22. The adjustable flood barrier assembly of claim 15, wherein said flood barrier assembly further comprises a flexible waterproof membrane.

23. The adjustable flood barrier assembly of claim 15, wherein said frame comprises two or more vertical members, wherein said vertical members are connectable to each other to adjust the lengths.

24. The adjustable flood barrier assembly of claim 15, wherein said frame comprise two or more horizontal members, wherein said horizontal members are connectable to each other to adjust the widths.

25. The adjustable flood barrier assembly of claim 19, wherein said flood barrier fit doorway opening of buildings and form water tight seal.

26. An adjustable flood barrier for structural doorway comprising: (a) a frame comprising vertical members, horizontal members and adjustable connection brackets; (b) a plurality of panels comprising panel edge returns, screw legs, tabs, and optionally a flat plate; and (c) a water seal;
wherein said adjustable flood barrier fit the doorway opening and form a water tight barrier.

27. The adjustable flood barrier of claim 26, wherein said plurality of screw legs comprise screws for communication with said flat plate and apply pressure onto said water seal.

28. The adjustable flood barrier of claim 27, wherein said screw legs further comprise a plate with internally threaded hole to hold said screw in position wherein said screw is in communication with said flat plate when advanced and tightened to apply pressure onto said water seal.

29. The adjustable flood barrier of claim 26, wherein said pluralities of panels comprise adjustable lower panels and adjustable upper panels to allow adjustments in the panel dimensions.

30. The adjustable flood barrier of claim 29, wherein the width of the panel is adjusted by a pair of lower panels that are arranged to horizontally slide onto each other to fit the doorway opening and form a water tight barrier.

31. The adjustable flood barrier of claim 26, wherein width of the panel is adjusted by a pair of upper panels that are arranged to horizontally slide onto each other to fit the doorway opening and form a water tight barrier.

32. The adjustable flood barrier assembly of claim 26, wherein said flood barrier assembly further comprise a flexible waterproof membrane.

33. An adjustable flood barrier for structural doorway comprising jambs, sill and head comprising: (a) a frame comprising adjustable connection brackets; (b) a plurality of panels; and (c) a water seal;
wherein said adjustable flood barrier form a water tight barrier at the structural doorway and protect from ingress of water.

34. The adjustable flood barrier of claim 33, wherein said plurality of panels comprise a plurality of screw legs comprising screws to apply pressure onto said water seal and form the water tight barrier.
